(19) United States
(12) Patent Application Publication
(10) Pub. No.: US 2025/0021374 A1
(43) Pub. Date: Jan. 16, 2025

(54) SELECTIVE ADDRESS TRANSLATION BLOCKING

(71) Applicants: Raghunathan Srinivasan, Chandler, AZ (US); Karthik V. Narayanan, Chandler, AZ (US); Francesc Guim Bernat, Barcelona (ES); Karthik Kumar, Chandler, AZ (US); Svyatoslav Pankratov, Hillsboro, OR (US)

(72) Inventors: Raghunathan Srinivasan, Chandler, AZ (US); Karthik V. Narayanan, Chandler, AZ (US); Francesc Guim Bernat, Barcelona (ES); Karthik Kumar, Chandler, AZ (US); Svyatoslav Pankratov, Hillsboro, OR (US)

(21) Appl. No.: 18/899,831

(22) Filed: Sep. 27, 2024

(51) Int. Cl. G06F 9/455; G06F 12/1045

(52) U.S. Cl. CPC G06F 9/45558; G06F 12/1063; G06F 2009/45583

(57) ABSTRACT

A hardware device receives a work request from a guest, the work request identifying a virtual address within a guest address space. The hardware device sends an address translation request to an address translation resource to translate the virtual address to a corresponding physical address in a physical address space. A blocking message is received from the address translation resource based on a determination that the virtual address is a faulty address and the blocking message identifies a source of the faulty address. The hardware device prevents a later address translation request for a later work request from the source based on the blocking message.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram of an example system implementing I/O virtualization.

FIG. 3 is a simplified block diagram illustrating an example computing system.

FIG. 4 is a simplified block diagram illustrating an example computing system implementing virtualization of an example physical function.

FIG. 5 is a simplified block diagram illustrating an example computing system including an infrastructure processing unit coupled to multiple host devices.

FIG. 6 is a simplified flow diagram illustrating a flow including an address translation.

FIGS. 7A-7B are simplified flow diagrams illustrating example fault handling involving an attempted address translation.

FIG. 8A is a simplified flow diagram illustrating blocking of address translation requests of an example guest process.

FIG. 8B is a simplified flow diagram illustrating the reallowance of address translation requests of an example guest process following the blocking of the guest process.

FIG. 9A is a representation of an example blocking message.

FIG. 9B is a representation of an example reset message.

FIG. 10 is a representation of example data structures.

FIG. 11 is a representation of an example capability register of an example physical device.

FIG. 12 is a representation of an example capability register of an example address translation resource.

FIG. 13 is a flow diagram illustrating an example technique for handling faulty address translation requests.

FIG. 14 illustrates a block diagram of an example processor device in accordance with certain embodiments.

Like reference numbers and designations in the various drawings indicate like elements.

### DETAILED DESCRIPTION

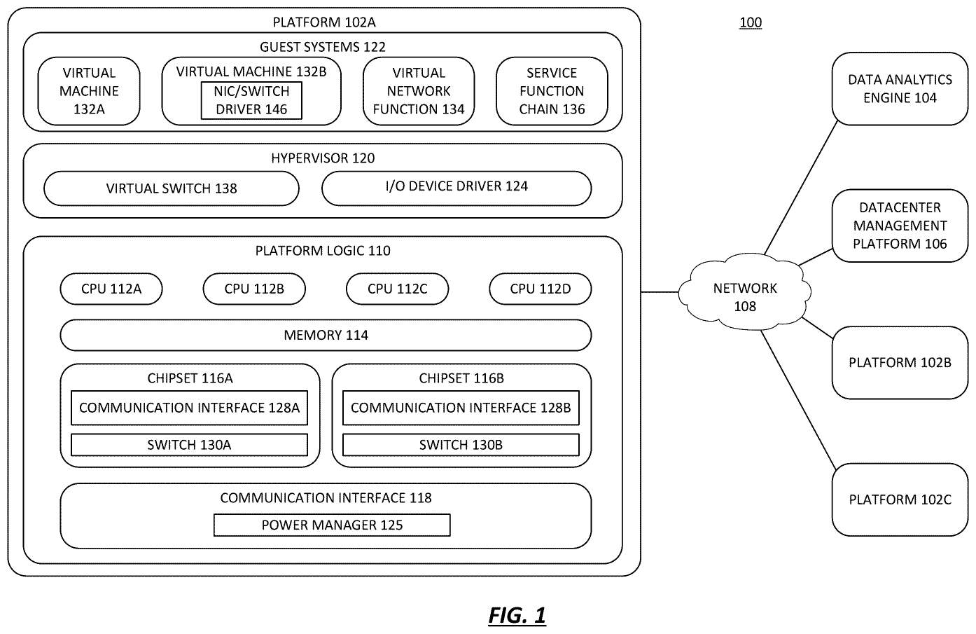

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. Various networking devices may be provided within the datacenter to provide resources facilitating communication for applications or services executed using the platform 102. In some cases, the hardware resources (e.g., physical functions) of these networking devices may be shared through virtualization or other techniques. Such systems may be enhanced, such as discussed below, to achieve host isolation in the sharing, between hosts, of these resources prevent head of line blocking to other hosts, among other example features.

A platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the respective CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, NVLink, Advanced Interface Bus (AIB), Infinity Fabric, Open Domain-Specific Architecture (ODSA), Bo-Wave Interconnect, Silicon Interconnect Fabric (Si-IF), Hybrid Bonding Interconnect, Chip-on-Wafer-on-Substrate (CoWoS), Integrated Fan-Out (InFO), Extra Short Reach (XSR) Interconnect, High Bandwidth Interconnect (HBI), among other example interconnect technologies, which may alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform. Further implementations may be supported, such as set forth above, for enhanced I/O virtualization. A host operating system may identify conditions and configurations of a system and determine that features (e.g., SIOV-based virtualization of SR-IOV-based devices) may be enabled or disabled and may utilize corresponding application programming interfaces (APIs) to send and receive information pertaining to such enabling or disabling, among other example features.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports). In some implementations, I/O virtualization may be supported within the system and utilize the techniques described in more detail below, for instance, to improve datacenter performance. Single Root I/O Virtualization (SR-IOV) and Sharing specification, version 1.0 (2007) by the Peripheral Component Interconnect (PCI) Special Interest Group (PCI-SIG), provided hardware-assisted high performance I/O virtualization and sharing of PCI Express devices. Intel® Scalable IOV (SIOV) and Application Defined Infrastructure (ADI) are additional input/output (I/O) virtualization specifications that may serve to markedly expands current Peripheral Component Interconnect Express (PCIe) device number limitations to increase a number of containers or services that can utilize a PCIe device, among other example technologies which may benefit from the implementations and features discussed herein.

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

Single Root I/O Virtualization (SR-IOV) is a PCI-SIG defined specification for hardware-assisted I/O virtualization that defines a standard way for partitioning endpoint devices for direct sharing across multiple virtual machines (VMs) or containers. A Virtual Machine (VM) may be implemented as a logical entity that is implemented over a hardware platform and operating system (OS). A VM can operate independently of other VMs implemented on the same hardware platform and yet utilize the same hardware resource through virtualization. An SR-IOV capable endpoint device provides a Physical Function (PF) and multiple Virtual Functions (VFs). The PF of a device in SR-IOV provides resource management for the device and is managed by a host driver running in the host operating system (OS). A provided VF can be assigned to a VM or container for direct access. SR-IOV-capable devices may provide high performance I/O, including I/O devices such as network and storage controller devices as well as programmable or reconfigurable devices such as GPUs, FPGAs, and other accelerators, among other examples.

Scalable IOV (SIOV) also seeks to define an approach for the virtualization of I/O, for instance, within a data center. SIOV provides hardware-assisted I/O virtualization that enables a higher degree of scalability and performance in the sharing of I/O devices across isolated domains (e.g., VMs and containers). In SIOV, flexible composition of virtual devices for device sharing is enabled. Accesses between a VM and a virtual device are defined in SIOV as either a “direct path” access or an “intercepted path” access. Direct-path operations on the virtual device are mapped directly to the underlying device hardware for performance, while intercepted-path operations are emulated at least partially in software by a Virtual Device Composition Module (VDCM) to enable this greater flexibility in I/O virtualization. Which operations and accesses are processed as intercepted path versus direct path may vary depending on the device implementation and application. For instance, slow-path operations (e.g., initialization, control, configuration, management, QoS, error processing, and reset) are treated as intercepted-path accesses and fast-path operations (e.g., work submission and work completion processing) are treated as direct-path accesses, among other examples.

Similar to SR-IOV, resources of a given physical device may be mapped to individual VMs. In SIOV, a more customizable and granular approach is adopted, with SIOV enabling the flexible definition of virtual devices (VDEV) that may be mapped to a respective VM. High performance I/O devices may include a large number of command/completion interfaces for efficient multiplexing/demultiplexing of I/O. SIOV platforms may enable the assignment of such interfaces to isolated domains at a fine granularity. An SIOV architecture defines the granularity of sharing of a device or device resource as an “Assignable Device Interface” (ADI). Each ADI instance on the device may encompass the set of resources on the device that are allocated by software to support the direct-path operations for a virtual device. For instance, resources on a device associated with work submission, execution, and completion operations may implement device backend resources (e.g., command/status registers, on-device queues, references to in-memory queues, local memory on the device, or any other device-specific internal constructs). An ADI may identify a set (e.g., all or a subset of the total device resources, or even a combination of resources of two or more discrete devices) of device backend resources that are allocated, configured, and organized as an isolated unit, forming the unit of device sharing. The type and number of backend resources grouped to compose an ADI may be device specific. Each SIOV ADI on a device function may use the same PCIe Requester ID (Bus/Device/Function (BDF) number) corresponding to the device's PCIe Function. Process Address Space Identifiers (PASID) may be used to distinguish upstream memory transactions performed for different ADIs and to convey the address space targeted by the transaction.

ADIs form the unit of assignment and isolation for devices and are composed by software to form virtual devices (VDEVs). A Virtual Device Composition Module (VDCM) is responsible for managing virtual device instances. For instance, for direct-path accesses, a VMM may map the direct-path accesses from the guest directly onto the provisioned ADIs for the VDEV. For intercepted-path accesses, the VMM identifies the intercepted-path accesses from the guest and forwards them to VDCM for emulation. VDCM emulates the intercepted accesses to the VDEV. In some cases, the VDCM may access the underlying physical device corresponding to the ADI (e.g., to read a corresponding device register, identify ADI status, configure the ADI's PASID, etc.). Virtual device composition, among other advantages, enables increased sharing scalability and flexibility at lower hardware cost and complexity. SIOV utilizes software to define and share device resources with different address domains using different VDEV abstractions. For example, application processes may access a device using system calls and VMs may access a device using virtual device interfaces. Virtual device composition can also enable dynamic mapping of VDEVs to device resources, allowing a VMM to over-provision device resources to VMs. For instance, the resources of one or multiple physical devices may be mapped to a given VDEV. VDEVs may thus be defined to achieve particular goals of the system. As an example, in a data center with various physical machines containing different generations (e.g., versions) of the same I/O device, VDEVs may be defined to present the same VDEV capabilities irrespective of the different generations of physical I/O devices used in the VDEV definitions. Such a solution may allow the same guest OS image with a particular VDEV driver to be deployed or migrated to various combinations or deployments of physical machines.

During operation, upstream memory requests from all ADIs (within respective VDEV mapped to various VMs or containers) may be tagged with the Requester ID of the device (or device function) hosting the ADIs. Requests from different ADIs of the device function may be distinguished using a Process Address Space Identifier (PASID). The Requester ID and/or the PASID may be used to identify (e.g., in a TLP prefix) the address space associated with the request. Accordingly, when assigning an ADI to an address domain (e.g., VM, container, or process), the ADI may be configured with a unique PASID of the address domain and its memory requests may be tagged with the PASID value (e.g., in a PASID TLP Prefix).

As introduced above, in SIOV, a VDEV may serve as the abstraction through which a shared physical device is exposed to guest software. In some implementations, a VDEV may be exposed to a guest OS as a virtual PCI Express device. A VDEV may be defined to possess virtual resources such as virtual Requester ID, virtual configuration space registers, virtual memory BARs, virtual MSI-X table, etc. Each VDEV may be mapped to or formed from one or more ADIs (corresponding to various devices or device functions). The ADIs backing a VDEV may belong to the same physical function or allocated across multiple functions (e.g., to support device fault tolerance or load balancing).

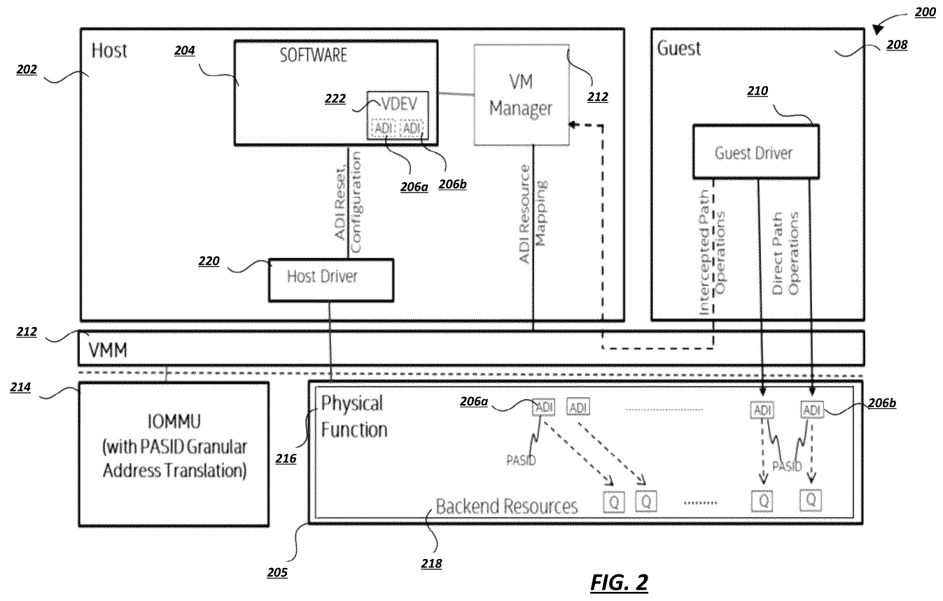

FIG. 2 is a simplified block diagram 200 illustrating a traditional implementation of an example operating environment 200 that supports the SIOV architecture to virtualize one or more devices (e.g., 205) such as component devices on a given computing system or other packages, such as accelerators, I/O devices, network processing devices, etc. In this example, the operating environment may include a host OS 202, a guest OS 208, a VMM 212, an input/output memory management unit (IOMMU) 214, and one or more devices (e.g., 205) possessing I/O resources capable of being virtualized (e.g., based on SR-IOV or SIOV, etc.). Host OS 202, guest OS 208, and/or VMM 212 may execute on the host hardware 104. Host OS 202 may include a host driver 220 and guest OS 208 may include a guest driver 210.

As shown, in conventional embodiments of SIOV environments, host OS 202 may include software 204 which may compose a virtual device (VDEV) 222 for the guest OS 208. In some embodiments, VDEV 222 may include virtual capability registers configured to expose device (or “device-specific”) capabilities to one or more components of operating environment 200. In various embodiments, virtual capability registers may be accessed by guest driver 210 of the device 205 to determine device capabilities associated with VDEV 222. The VDEV 222 may include one or more assignable device interfaces (ADIs) (also referred to as “assignable interfaces”), including an ADI 206a and an ADI 206b. In some embodiments, an ADI may be assigned, for instance, by mapping the ADIs 206a-206b into a MMIO space of the VDEV 222. An ADI generally refers to the set of backend resources 218 of the device 205 that are allocated, configured, and organized as an isolated unit, forming the unit of device sharing of the device 205. The type and number of backend resources 218 grouped to compose a given ADI 206a, 206b, may be specific to the device 205. An ADI 206a, 206b may be associated with a device context, rather than with specific device resources. As another example, the backend resources 218 of the ADIs 206a-206b may include one or more shared work queues. A repository (not pictured) or other data structure may store a plurality of different ADIs and the respective attributes of each ADI.

For example, if the device 205 is a network controller, the ADIs 206a-206b may provide backend resources 218 that include transmit queues and receive queues associated with a virtual switch interface. As another example, if the device 205 is a storage device, the ADIs 206a-206b may provide backend resources 218 that include command queues and completion queues associated with a storage namespace. As yet another example, if the device 205 is a graphics processing unit (GPU), the ADIs 206a-206b may provide backend resources 218 that include dynamically created graphics or compute contexts, among other example devices and ADIs.

The IOMMU 214 may be configured to perform memory management operations, including address translations between virtual memory spaces and physical memory. As shown, the IOMMU 214 may support translations at the Process Address Space ID (PASID) level. Generally, a PASID may be assigned to each of a plurality of processes executing on the host hardware 104 (e.g., processes associated with guest OS 208 and/or VMs). Doing so enables sharing of the device 205 across multiple processes while providing each process a complete virtual address space.

In some implementations, software 204 may implement a VDCM. In some instances, a distinct instance of software 204 (or a VDCM) may be provided for each device which is to be virtualized. For instance, a VDCM may be implemented as a device-specific component responsible for composing and implementing VDEV instances 222 using one or more ADIs allocated, for instance, by a host driver 220. The VDCM implements software-based virtualization of intercepted-path operations and arranges for direct-path operations to be submitted directly to the backing ADIs. The host driver 220 may be loaded DCMs may be implemented and packaged by device vendors in a various ways, such as user-space modules or libraries that are installed as part of the host driver or a. In other implementations, the VDCM may be a kernel module. If implemented as a library, the VDCM may be statically or dynamically linked with the hypervisor-specific virtual machine resource manager responsible for creating and managing VM resources. If implemented in the host kernel, the VDCM can be part of the host driver. The host driver is loaded and executed as part of the host OS or hypervisor software. The host driver may report support for SIOV (and/or SR-IOV) to system software through the driver interface. In addition to traditional device driver functionality, the host driver 220 may implement software interfaces (e.g., as defined by the host OS or hypervisor infrastructure) to support enumeration, configuration, instantiation, and management of ADIs. The host driver may be responsible for configuring the ADIs, including aspects such as PASID identity, Interrupt Message Storage entries, MMIO register resources for direct-path access to the ADI, and any device-specific resources, among other example functionality and features. An SIOV compatible guest driver 210 may manage the VDEV instances composed by the VDCM. Direct-path accesses by the guest driver 210 may be issued directly to the ADIs (e.g., 206a-b) mapped to the VDEV, while intercepted-path accesses are intercepted and virtualized by the VDCM (e.g., 204). In some implementations, guest and host drivers can be implemented as a unified driver that supports both host and guest functionality or as two separate drivers. For existing SR-IOV devices, if the VDEV can be composed to behave like an existing VF, the Intel Scalable IOV guest driver can be same as the SR-IOV VF driver, among other examples.

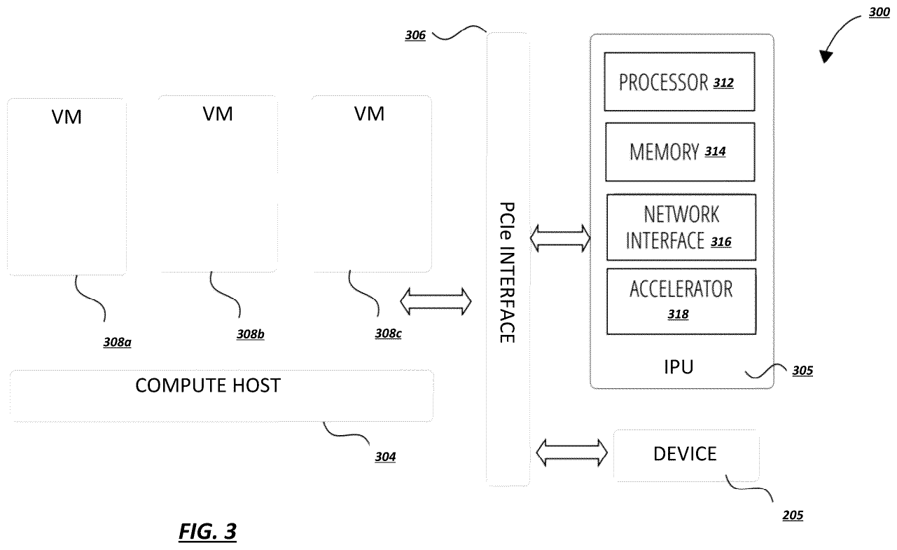

Turning to FIG. 3, a simplified block diagram 300 is shown illustrating an example network interface device 305, such as an infrastructure processing unit (IPU), smart network interface controller (smart NIC), or other networking device posing networking interfaces, networking circuitry, memory, and microcontroller (e.g., CPU). In this example, a network interface device 305 is coupled to host hardware 304, and a device 205 coupled via a PCIe interface 306. The network interface device 305, host hardware 104, device 205, and PCIe interface 306 may be implemented in circuitry. For example, the network interface device 305, host hardware 304, device 205, and PCIe interface 306 may be communicably coupled components of a compute node, server blade, server rack, or any other computing hardware. The host hardware 304 includes at least one processor circuit and memory (each not pictured). network interface device 305 also includes at least one processor 312, memory 314, an accelerator 318, and a network interface device 316 (e.g., a wired and/or wireless Ethernet network interface). The network interface device 316 may provide an interface to other devices via a network (e.g., a local area network (LAN), a wide area network (WAN), the Internet, etc.) and may support the Institute of Electrical and Electronics Engineers (IEEE) suite of Ethernet standards (e.g., 802.1, 802.3, etc.). The device 205 may be any type of peripheral device, such as a PCIe-compatible device. Although the PCIe interface 306 is used as a reference example of an interface, other interfaces may be used in the operating environment. For example, a Compute Express Link® (CXL) interface, a peripheral component interconnect (PCI), interface, a universal serial bus (USB) interface, a serial peripheral interconnect (SPI), an integrated interconnect (12C), or a Universal Chiplet Interconnect Express (UCIe) interface may be used instead of the PCIe interface 306, among other examples. Therefore the device 205 may be a USB device, PCI device, PCIe device, CXL device, UCIe device, I2C, and/or an SPI device and provide I/O resources (e.g., for virtualization) in accordance with its corresponding I/O protocol or technology. The network interface device 305 further includes a direct memory access (DMA) engine to facilitate DMA transactions, among other example features.

The host hardware 304 may be representative of one or more processors and memory to execute one or more virtual machines (VMs), such as VM 308a, VM 308b, and VM 308c (or other containers or other isolated domains). The network interface device 305 includes one or more programmable or fixed function processors to perform offload of operations that could have been performed by processors of the host hardware 304. The network interface device 305 may therefore be considered as an “offload device.” More generally, the network interface device 305 may perform virtual switch operations, manage storage transactions (e.g., compression, cryptography, virtualization), and manage operations performed on other IPUs, smart NICs, compute nodes, servers, and/or devices.

Various hardware accelerators (e.g., networking processors, smart NICs, streaming accelerators, compression accelerators, machine learning accelerators, encryption accelerators, etc.) may support virtualization technologies (e.g., SR-IOV SIOV, and others), allowing the physical functions of the device to be partitioned into multiple virtual devices (e.g., ADIs, virtual functions (VFs), etc.) to allow multiple virtual machines or containers, virtualized operating systems (or “guest” OSes), virtualized drivers, and application and processes running on top of such virtual machines and guest systems to share the physical device and its hardware resources (e.g., using a hypervisor) across multiple virtual machines. Accordingly, through virtualization, single hardware device can be shared by many VMs or containers. Further, a VMs or container may share an ADI among multiple applications, services, or microservices, adding another layer of partitioning. In some implementations, VMs may be identified by a respective, unique Domain ID (DID). Each domain corresponding to a DID (and VM) can contain multiple isolated address spaces inside it which are identified by a Process Address Space Identifier (PASID). PASID identifies the address space targeted by various memory requests (e.g., Direct Memory Access (DMA) requests).

While the examples herein may refer to the deployment of solutions (e.g., address translation request fault handling and blocking) within the context of a data center or cloud computing environment, it should be appreciated that these solutions, components, and techniques may be adapted for and implemented in other system architectures, including edge computing architectures (e.g., edge architectures employing virtualization), personal computing architectures (e.g., laptops, smart phones, set-top boxes), among other examples (e.g., in-vehicle systems, robotic systems, etc.) where various components may share and compete for use of one or more address translation resources provided in the system.

With the advent of virtualization technologies, such as SIOV, a physical function (corresponding to a physical hardware device) can service requests from multiple address spaces. For instance, a single PF may have multiple ADIs that are assignable to processes running on one or more VMs or container. Through shared memory resources (e.g., Shared Virtual Memory (SVM)) applications and services running within a VM can submit work to a virtualized physical device directly by using a Guest Virtual Address (GVA) or a Guest Physical Address (GPA). Hardware-based address translation resources, such as an I/O memory management unit (IOMMU), may be utilized to perform translations between virtual and physical address spaces, for instance, translating between an input address provided by the process to a Host Physical Address (HPA) the physical device can use to perform requested or other operations. Such address translation hardware resources may also be shared in the sense that address translation requests emanating from multiple different processes on multiple VMs may be handled by the same translation hardware. However, if a process utilizing an ADI or VF repeatedly submits bad work descriptors to the physical device, for instance, because the process includes buggy or inefficient code or is a malicious process (e.g., attempting to execute a denial of service attack on the system), address translation and remapping hardware (e.g., an IOMMU) serving the device can be overwhelmed by the extra cycles used to handle address translation errors and fault. In such instances, the IOMMU would spend considerable resources processing such faults, at the expense of potentially large performance losses (e.g., causing “good” processes' address translation requests to suffer in performance and slow the performance of these processes). For instance, valid requests from legitimate processes (and corresponding VFs or ADIs) may not have sufficient access to the shared IOMMU resource due to the IOMMU being dedicated to addressing numerous page faults associated with requests of a buggy or malicious process, among other examples.

In an improved system, hardware implemented logic may be included in a system to block a rogue address space from issuing repeated faults on a system in order to improve performance and availability of a shared address translation resource. Traditional systems engage in fault handling that may resort to terminating an entire VM associated with a rogue address space. Such solutions, however, may be costly, as the same VM may concurrently handle other services and processes, including system critical processes, which would also be terminated along with any faulty or otherwise problematic processes on the VM. Further, hypervisor-based fault handling may lack the ability to detect, with precision, a source of faults relating to a faulty address space. Moreover, in a typical datacenter, some VMs may be legacy VMs (which have not been sufficiently upgraded to detect or participate in fault handling), which may result in legacy guests running on top of a hypervisor, limiting the hypervisor's ability to address faults through software-only approaches Additionally, in systems employing more than one node accessing a shared memory and address translation resource (e.g., over an IPU or smartNIC) the abstraction provided through the use of the IPU or smartNIC may obscure a software-based fault handling approach, among other example issues.

In one example implementations, an architecturally defined protocol (e.g., PCIe and PCIe Address Translation Service (ATS) nay be leveraged, which is not dependent on dependencies of a guest VM implementation, to implement improved fault handling between a hypervisor and various VMs and corresponding guest OSes, which enables the hypervisor to detect that a certain PASID space was repeatedly issuing bad addresses (e.g., Guest Physical Address, Guest IOVA, Guest Virtual Address) and communicate related information to a Guest VM. In a multi-tenant environment, this problem may be exacerbated given the possibility of different guest OSes running on different Hypervisors/VMMs. Further, the hypervisor may be able to attempt to “bound” or limit the impact of a badly behaving VM (e.g., based predefined limits, programmable quality of service bounds, or other policies). Such an implementation may be used to detect and isolate a process issuing bad addresses to a shared address translation resource (e.g., an IOMMU), while allowing the VM to continue functioning undisturbed, among other example use cases, implementations, and advantages.

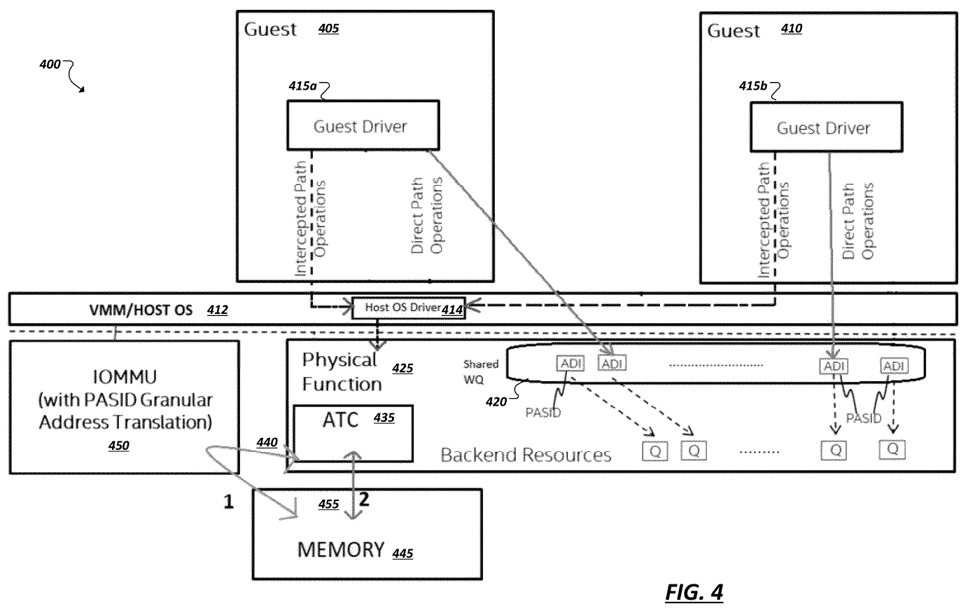

Turning to the simplified block diagram 400 of FIG. 4, a portion of a computing platform is illustrated (such as one included within a cloud server or data center environment), where multiple guests 405, 410 (e.g., virtual entities such as virtual machines or containers) utilize respective guest drivers (e.g., 415a-b) to access and use shared work queues (SWQ) (e.g., 420) of a physical device 425 (e.g., an SIOV- or SR-IOV-capable device) to share virtualized instances of the physical hardware resources of the physical device between the processes run within the guests 405, 410 (which may be instantiated on the same computing system or separate distinct (e.g., remote) computing systems). In this example, the guests 405, 410 may be implemented on a virtual machine manager, hypervisor, or other software running on a host operating system (e.g., 412) of one or more computing platforms. The guest drivers 415a-b may interface with a host driver 414 to facilitate an interface between the guests 405 and 410 and virtual instances (e.g., VFs or ADIs) of the physical device 425, among other example implementations.

In this example, the physical device 425 may not only support queues (e.g., 430a-#), including shared work queues (e.g., 420)), but may also maintain an address translation cache (ATC) 435 (or other resources to assist in handling address translation requests), for instance, to save known mappings of guest addresses (e.g., from the respective guest address spaces of either guest 405 or guest 410) with address in the physical host address space (e.g., for use in subsequent address lookups). For instance, incoming requests to the physical device 425, which reference an address in a memory accessible through the physical device, may be attempted to be matched against existing address mappings cached by the ATC 435. If there is a miss in the ATC 435, the physical device 425 may submit an address translation request 440 to address translation hardware 450 (e.g., an IOMMU corresponding to a memory (e.g., 445)) for the address translation hardware to complete. For instance, an IOMMU 450 may receive the request 440 and translate the guest address included in the request to its corresponding host address and returns a response to the physical device 425. The physical device 425 may store the translation in its ATC 435, and then sends out a translated request 455 to access the corresponding data in memory 445.

In some implementations, the SIOV may be used to provide hardware assisted I/O virtualization that enables highly scalable and high-performance sharing of physical devices across isolated domains. Isolated domains can be VMs, containers, processes, or any domain abstractions. Each abstraction is identified by a unique PASID. Each physical device (e.g., 425), such as hardware accelerators or other hardware elements, can be partitioned into multiple ADIs. All ADIs on a device function use the same PCIe Requester ID (Bus/Device/Function number) corresponding to the device's PCIe Function. PASIDs may be used to distinguish memory transactions performed by ADIs for different address spaces. Any remapping hardware that supports SIOV for devices may also support Scalable Mode translation tables which can correctly translate requests for a device per address space. Upstream memory requests from all ADIs may be tagged with the Requester ID of the device function hosting the ADIs, among other example implementations.

The translation hardware, or translation agent (TA) (e.g., an IOMMU) may utilize translation tables to satisfy memory access requests issued by the physical device 425. An IOMMU may also be used to determine whether the guest (and related address space) providing the request is making a valid request. In cases where the address space attempts to access an address without a valid translation in the IOMMU, a fault is raised. In some implementations, if Address Translation Service (ATS) or a similar protocol is not enabled, the IOMMU may raise a non-recoverable fault, which is then handled by fault handler logic (e.g., an IOMMU/VT-d fault handler routine in system software). In the absence of ATS and Page Request Service (PRS) protocols, the typical system software approach is to simply terminate the guest and address space originating the request (e.g., terminating the entire VM from which the request originated (e.g., even if some processes on the VM operate reliably with valid address requests. In cases where an address translation protocol (e.g., ATS, PRS, etc.), the IOMMU may send a recoverable fault to the physical device (e.g., to its translation lookaside buffer (TLB) or ATC. The physical device (e.g., through the ATS or TLB) may attempt to address the page fault. In some implementations, this is done with the help of the IOMMU and system software (e.g., using the PRS protocol). For instance, system software may respond by processing the page fault and sending a page group response to the physical device. If the request was invalid, the Invalid Request flag is sent to the device. A rogue guest or address space using a physical device can repeatedly send a faulting address. This will create a penalty on the IOMMU and the platform to handle and service faults. This will also take compute cycles away from other guests (e.g., other VMs and process spaces) that have genuine requests that need to be translated by the IOMMU or other shared translation hardware.

Accordingly, an improved system may be provided with logic implemented to prevent a malicious process and/or address space from swamping address translation resources, such as an IOMMU. For instance, based on a faulting address (or pattern of faulting addresses submitted by a particular process, a protocol may be utilized to identify the offending process and alert the physical device through a defined messaging protocol to block, or drop, future requests from this physical device. For instance, an ATS-based message may be used to alert a physical device (e.g., to update its ATC or TLB) to drop future requests from an address space due to the detection of a one or more faulting addresses originating from this address space or guest. System software may also be utilized to configure the physical device or other logic on the platform to assist in implementing or enforcing quality-of-service policies through the policing of faulting addresses on the platform. As an example, a system software stack (e.g., VMM or OS) may configure the proposed hardware to fix the rate at which these type of failures may happen per VM or PASID. System software may also be used to provide a software interrupt or other messaging to an application (e.g., associated with the faulting address space) notifying that this error is occurring and some level of QoS throttling will be applied (e.g., N failures for every millions of instructions), among other examples.

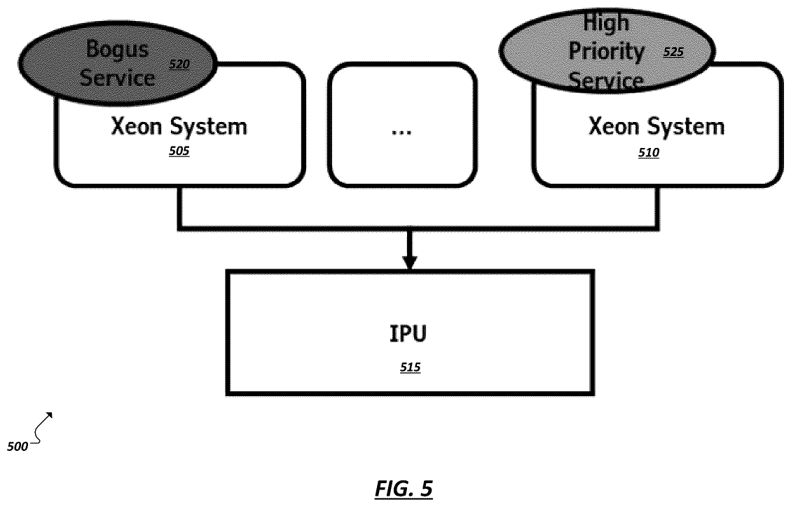

The ability of one address space with shared access to a physical device to issue incorrect address translation requests (or faulting addresses) to the physical device (e.g., to perform a DOS attack or which otherwise degrades performance), may also affect other computing platform architectures. Turning to FIG. 5, a simplified block diagram 500 is shown of a two computing platforms 505, 510 with their own address spaces, are respectively coupled to an IPU 515. The IPU 515 may couple the devices 505, 510 to a network and provide address translation resources for translating addresses to/from the respective address space domains of devices 505, 510. As in the example of FIG. 4, a service (e.g., 520) may issue incorrect requests that include faulting addresses, which are directed to the IPU 515. Faulting addresses may result in fault handling routines performed at the IPU, which may negatively impact performance of the IPU as well as other services (e.g., a high priority service 525 hosted on another one of the systems 510), which effectively compete for translation resources of the IPU 515 with other devices (e.g., 505) coupled to the IPU. The IPU may detect instances of faulty translation requests and may message a block within the IPU to cause subsequent address translation requests from a misbehaving service (e.g., 520) to be dropped prior to being forwarded to the address translation block (e.g., to avoid negative performance impacts or a DOS attack, among other examples). A translation request may be determined to be incorrect or faulty based on the translation request including a virtual address, which address translation resources (and potentially also system software) are unable to map to a physical address of the system or which maps incorrectly (or even maliciously) to a given physical address, among other examples. It should be appreciated that the techniques and protocols discussed herein may be adapted and applied to a variety of computing platform architectures to provide a message to communicate details of a rogue address space to a device to allow the device to assist in preventing this address space from clogging up the shared address translation resources of the platform by causing subsequent requests invoking address translation from this address space to be dropped.

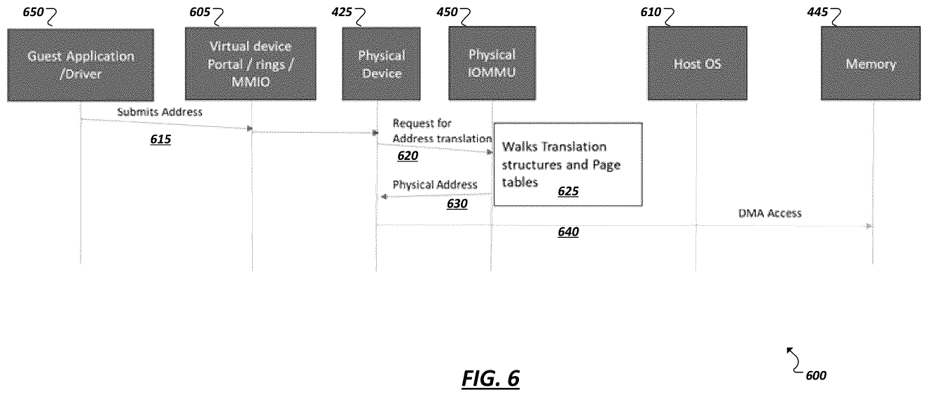

FIG. 6 is a simplified flow diagram 600 illustrating an example flow for handling a request for address translation from an application or driver on a guest (e.g., VM or OS) with a respective address space. For instance, an application or driver (e.g., 650) on the guest may submit work 615 to a device 425 (e.g., a shared accelerator, an IPU (e.g., as in the example of FIG. 5), etc.) through an interface 605 (e.g., implemented as an exposed ring pair, queue, memory mapped input/output (MMIO) portal, etc.). The work request may include an address descriptor of the guest address space for the device 425 to seek/read data from or write data to in connection with the work request (e.g., data to be operated read and operated upon by an accelerator, a descriptor pointing to a memory destination for the physical device to direct or write data to, etc.). In normal operation, the physical device 425 may receive the request 615 and identify an address referenced in the request 615 (e.g., using a descriptor) and may first consult its ATC or TLB (if provided on the device 425) and if the address mapping (e.g., to a host address space corresponding to a host OS 610 and host memory 445) is not cached, sends a request for address translation 620 to an address translation resource 450, such as a translation agent, IOMMU, or other hardware-implemented logic. As an example, an IOMMU 450 may process the request 620 by walking its translation structures and page tables (at 625) to determine the mapped-to physical address corresponding to the submitted guest address. The IOMMU 450 returns the address mapping result 630 to the physical device 425, allowing the physical device 425 to perform additional work relating to the request 615 by using the physical address to access (at 640) related data in physical memory 445 (e.g., using direct memory access (DMA)), among other examples.

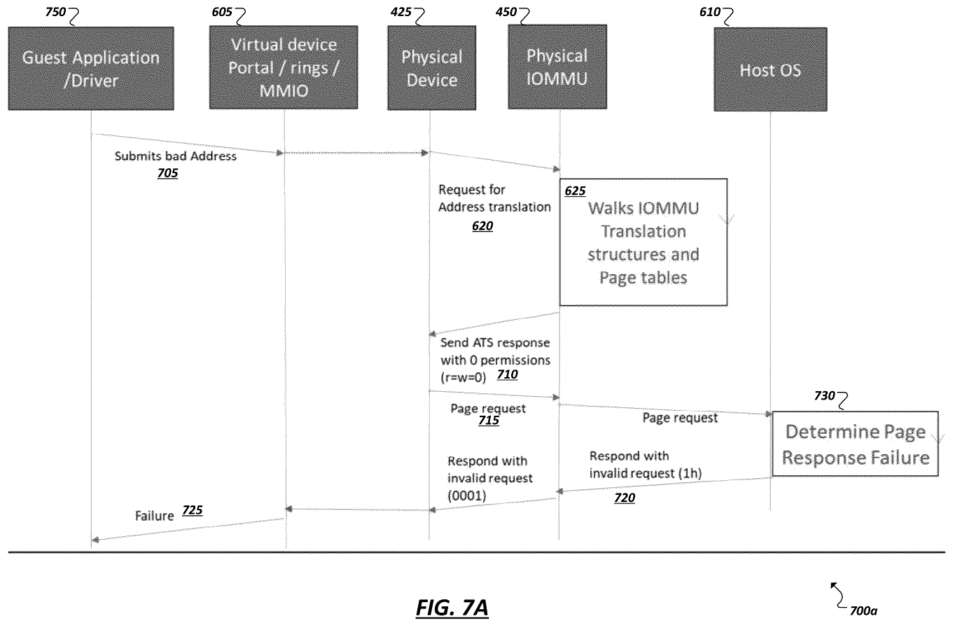

Turning to FIGS. 7A-7B, flow diagrams are shown illustrating examples where a given process, service, or application (e.g., 705) in a guest sends a faulty address with a work request 705 (e.g., deliberately or maliciously, or inadvertently through a bug or instability in the agent or a process run on the agent), thereby triggering fault handling by the system. For instance, FIG. 7A illustrates an example recoverably fault flow. For instance, the IOMMU may walk its translation structures and page tables and determine that the provided guest address is “bad” and is not mapped to physical address. In one example, the IOMMU may send a message 710 (e.g., via ATS and PRS) to trigger a page request flow 715 by the physical device 425 with the host OS 610 to identify (at 730) the invalid request and prompt 720 the physical device 425 to communicate the failure 725 back up to the guest application or process. If ATS, PRS, or other fault handling capabilities are not available or the fault is one that exceeds the capabilities of the recoverable fault handling by the platform, a non-recoverable fault may instead be triggered (e.g., a VT-d fault 760). For instance, the IOMMU may generate a recoverable or a non-recoverable fault based on where the address translation/page walk failed. FIG. 7B shows an example flow for handling of a fault caused by a bad address included in a work request 705 that results in the determination of a non-recoverable fault. In this example, based on the address translation attempt 625 of the IOMMU 450, the IOMMU determines a non-recoverable fault and raises the fault 7670 to the host OS 610, causing the host OS to terminate the guest application or driver 750, or even the VM or container in which the guest application runs, which may have the undesired side-effect of terminating other, well-behaving or even critical applications running in the guest, among other example disadvantages. If a guest application, driver, service, or process is sending numerous bad requests resulting in tying up the shared translation hardware 450 in fault handling activities (or resulting in other guest processes being interrupted or terminated), the offending guest application may cause outsized negative impacts on the overall performance of the system. As introduced above, an improved system may introduce and implement logic to support messaging (e.g., enhanced ATS messages) to inform the physical device to gatekeep against address translation requests relating to work requests (e.g., 705) that originate from a guest process identified as sending bad or faulting addresses in their requests.

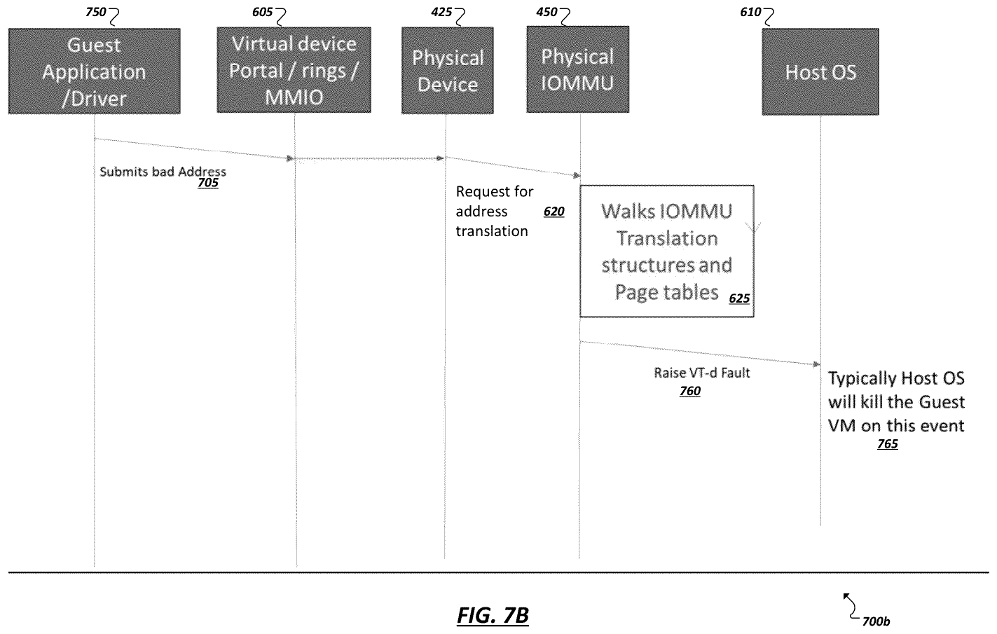

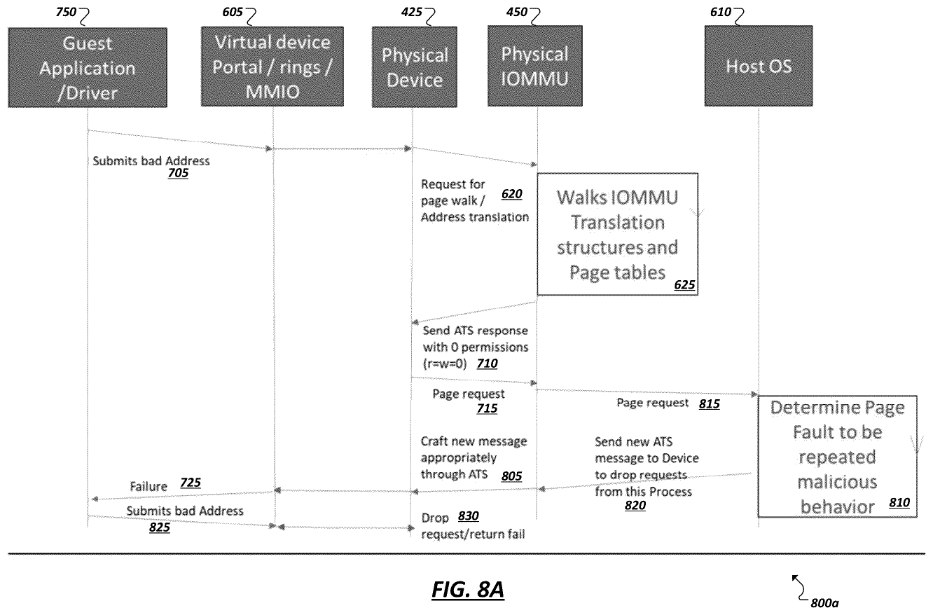

Turning to the examples of FIGS. 8A-8B, simplified flow diagrams 800a-b are shown illustrating an example flows utilizing an enhanced ATS message 850 to facilitate the selective dropping of potentially bad address submissions by a given guest process 750. In this example, the flow begins as in the fault examples of FIGS. 7A-7B, with a given guest process 750 submitting a work request 705 with a bad guest address. The physical device 425 may identify from its ATC that it does not know the mapping for this address and submit a request address translation 620 to address translation hardware that is used in connection with the virtualization of the physical device 425 by one or more guest processes running on one or more guests. The IOMMU may determine that a recoverable or non-recoverable fault exists based on the bad address and its translation attempt 625, which may trigger a message (e.g., 815) to the host OS 610 (or other system software) to report the fault.

Continuing with the example of FIG. 8A, the host OS 610 or other system software may be equipped with software-implemented logic to track (e.g., by guest process, PASID, etc.) the number or frequency of bad address submissions, whether the submissions trigger recoverable or non-recoverable faults, among other information describing instances where a bad address submission was detected in association with a physical device 425 (or for multiple respective physical devices shared and virtualized within the system). Further, the host OS 610 may consider service level agreements (SLAs), QoS, and other policies applying to respective guests (e.g., VMs, guest OSes) or guest processes in determining how much leeway to grant a corresponding guest process that has issued one or more work requests (e.g., 705) with bad or faulting addresses. Based on the tracking of such bad address submissions, thresholds determined for the permissible frequency of such submissions (e.g., which may vary based on the corresponding guest and related policies applying to the guest, a customer associated with the guest, a time of day, the amount of capacity of the computing platform (e.g., where more capacity may allow for more forgiving handling of bad address submissions), etc.), the host OS 610 may determine that future address translations associated with work requests by the guest process (or all processes on a given guest VM or OS) should be blocked by refusing corresponding address translation requests from the physical device 425 to the address translation resource 425. In this case, the host OS 610 determines (at 810) that the guest process or address space (e.g., 750) has creating too many rogue address faults, and sends a message 820 back to the IOMMU to respond to the fault by sending a message 805 (e.g., based on ATS or PRS) to inform the physical device 425 to block subsequent requests from the guest address space 750.

Continuing with this example, when a physical device 425 receives the blocking message 805, the physical device 425 may record that future work requests from an address space or process identified in the message 805 should be dropped (e.g., by updating a table within or managed by the physical device (e.g., 425)). For instance, following the receipt of the blocking message 805, another work request 825 may be received at the physical device 425, which is identified as a work request with an address from a process and/or guest address space previously identified to the physical device 425 through a blocking message (e.g., 805) that should be blocked. Accordingly, the physical device 425 may drop 830 the request and return a fail to the guest process 750. In some implementations, information may be provided to the guest process 750 indicating that its requests are being blocked and an additional flow or protocol may be utilized to allow the guest to coordinate with the system software (e.g., 610) to potentially resolve the issue behind the faulting addresses (e.g., reconfiguring the address space, terminating a particular (e.g., malicious) process behind the faulting addresses, etc.). This can be done in a targeted way, avoiding fault handling that leads to performance issues with the shared translation resources (e.g., 450) and avoids overly aggressive remediation (e.g., terminating an entire VM rather than a specific process run in the VM), among other example benefits.

When a guest process and address domain are blocked based on the communication of a blocking message (such as shown in the example of FIG. 8B), this blocking may be permanent, or prolong until the guest process and/or guest are torn down. In other cases, the blocking may be temporary, enabling the host (e.g., through its system software) to determine that a faulting address domain has been corrected or should be otherwise allowed Turning to FIG. 8B, in one example, following the flow discussed in the example of FIG. 8A, where a work request 705 triggers a fault and causes a blocking message 805 to be sent that results in a future work request 825 being dropped 830 at the physical device 425, system software (e.g., host OS 610) may (e.g., after communicating and collecting diagnostics or other information from the guest process or its guest VM or OS) may determine that a remediation may be applied (e.g., 850) to resolve the basis for the system software initiating the blocking of address translation from the guest address domain (e.g., associated with a given PASID or DID). Upon determining that the block may be lifted, a reset message may be initiated, with the host OS 610 sending a reset descriptor 855 identifying the guest process or domain that is to be reset and requesting the address translation hardware (e.g., an IOMMU) 450 to issue a reset message 860 (e.g., an enhanced ATS or PRS message) to the physical device 425 to cause the block to be lifted. Upon receiving the reset message 860, the physical device 425 may update its records to reflect that address translations involving the identified address space may again be the basis of address translation requests to the IOMMU 450. In some implementations, the physical device 425 may send an indication (e.g., through interface 605) to the guest that the block has been lifted. Once a reset has been completed for the guest address and/or guest process at the physical device 425, the next time the guest process 750 submits a work request (e.g., 865) with a guest address, the physical device 425 may handle the work request as it typically would, for instance, by consulting its ATC or TLB and sending a request for address translation (if the mapping is not cached) to the IOMMU 450 for translation (at 875). Provided the address translation 875 does not result in another error or fault, the IOMMU (or other address translation resource) may return the physical address corresponding to the guest address in the request 865 to the physical device, which the physical device 425 may use to access 885 corresponding data in memory 445 and complete the requested work.

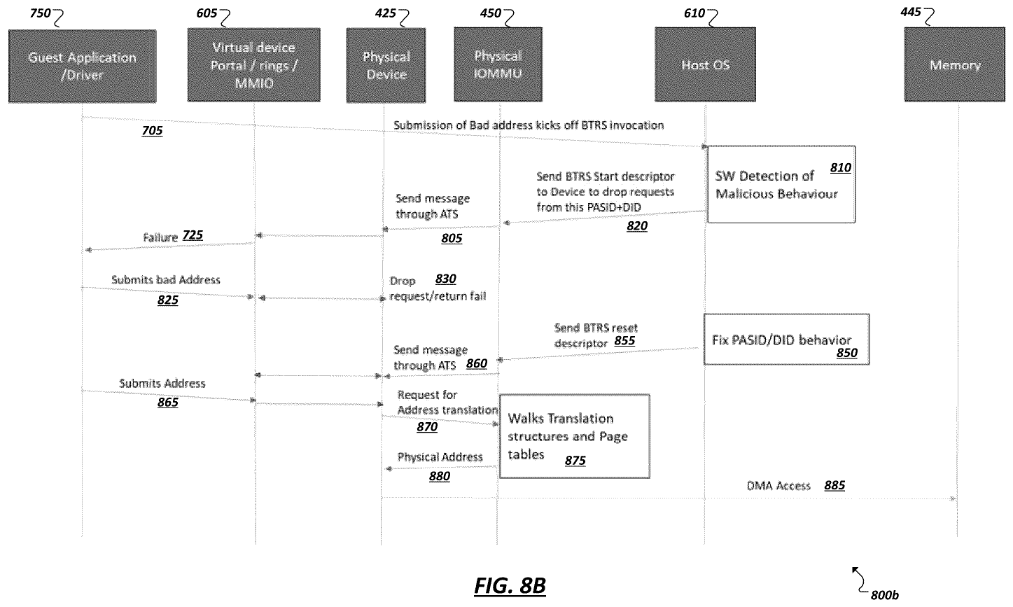

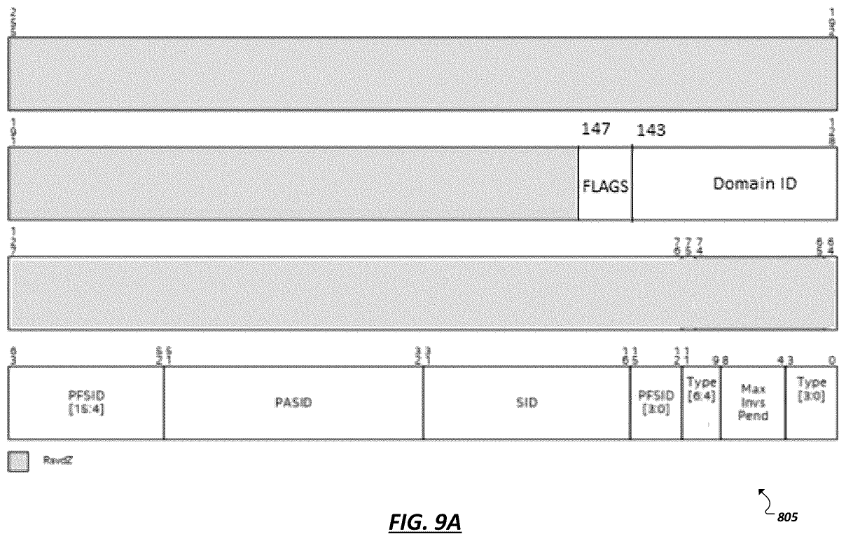

As noted above, a blocking message and reset message, such as discussed herein, may be implemented by enhancing an existing protocol, such as well-established and commonly supported protocol such as ATS. As an example, FIG. 9A illustrates an example implementation of a blocking message 805 according to ATS to implement the blocking message through a block translation request support (BTRS) descriptor. In this example, the fields of the BTRS descriptor may include those described in Table 1:

TABLE 1
Example Fields of a BTRS Start Descriptor

| FIELD | LOCATION | DESCRIPTION |
|---|---|---|
| Type | [11:9], [3:0] | Denotes start of the block operation (e.g., through value |
| | | 0xC) |
| Max Invs Pending | [8:4] | VT-d specification value |
| Physical Function | [15:12] | VT-d specification value |
| Source ID | | |
| Source ID (SID) | [31:16] | The SID field indicates the source-id of the endpoint |
| | | device whose DID/PASID memory/IO submission |
| | | policy needs to be configured. |
| PASID | [51:32] | Value is a 20-bit field that indicates the rogue address |
| | | space. |
| Domain ID | [143:128] | 16-bit value specifying the domain ID of the Address |
| | | space/VM. |
| Flags (4-bit) | [147:144] | Indicates the scope of the blocking (e.g., by PASID, |
| | | address domain, or some other identifier) |

The Flag field of the blocking message may identify the process, VM, and/or address domain that is to be subject to blocking, with the physical device using this information to map incoming addresses in requests with those which should be dropped. For instance, in one example, the Flag field may implement a bitmask to identify which descriptor values the physical device is to use to block incoming requests. For instance, Flag values may include two single bit flag values (with other bits of the field being reserved), including USE_PASID (to indicate to the physical device to use the PASID provided in descriptor to block/ignore requests) and USE_DOMAIN_ID (to indicate to the physical device to use the Domain ID provided in descriptor to block/ignore requests), where if both bits 144 and 145 are set, the physical device is to should filter out requests that match both Domain ID and PASID, among other examples. In some implementations, a descriptor block message (e.g., 905) in ATS may be followed by an Invalidation Wait Descriptor to sync and make sure the device was able to execute the command, among other examples.

Turning to FIG. 9B, an illustration of an example implementation of a reset message 860 is shown, based on an ATS protocol. The reset message may be implemented as a BTRS reset descriptor (corresponding the BTRS descriptor shown in FIG. 9A), with values such as those outlined in Table 2:

TABLE 2
Example Fields of a BTRS Reset Descriptor

| FIELD | LOCATION | DESCRIPTION |
|---|---|---|
| Type | [11:9], [3:0] | Denotes a blocking reset operation (e.g., through value |
| | | 0xD) |
| Max Invs Pending | [8:4] | VT-d specification value |
| Physical Function | [15:12] | VT-d specification value |
| Source ID | | |
| Source ID (SID) | [31:16] | The SID field indicates the source-id of the endpoint |
| | | device whose DID/PASID memory/IO submission |
| | | policy needs to be configured. |
| PASID | [51:32] | Value is a 20-bit field that indicates the address space for |
| | | which the block/drop should be cleared. |
| Domain ID | [143:128] | 16-bit value specifying the domain ID of the Address |
| | | space/VM. |
| Flags (4-bit) | [147:144] | Indicates the scope of the blocking reset (e.g., by PASID, |
| | | address domain, or some other identifier) |

Similar to the example of Table 1 and FIG. 9A, the Flag field in the reset message may indicate the scope of the reset. For instance, corresponding to the example of FIG. 9A, two bits may be used, including o USE_PASID [144]: This indicates to the device to use the PASID provided in descriptor to reset requests and USE_DOMAIN_ID [145]. This indicates to the device to use the Domain ID provided in descriptor to reset requests), where setting both bits implies that the physical device should filter out requests that match both Domain ID and PASID, among other example implementations. In some instances, the reset descriptor may also be followed by an Invalidation Wait Descriptor to sync and make sure the device was able to execute the command, among other examples. It should be appreciated that messages of other protocols (e.g., non-ATS protocols) may be extended in similar manner to serve as a mechanism to request a physical device to enforce blocking of address translation requests from rogue, faulty, or other processes issuing fault guest addresses, among other examples.

The physical device and/or address translation hardware may include registers, tables, or other structures to track address translation faults, as well as instructions to block a given guest process. For instance, IOMMU hardware may implement Fault Status registers to report and log non-recoverable (and potentially also recoverable) fault events. The errors may be reported by the IOMMU hardware on a “Start/Stop Reservation Descriptor” submission classified as an Invalidation Queue Error (IQE). The conditions resulting in an IQE error can be obtained by looking into another hardware register, Invalidation Queue Error Record Register (IQERCD_REG). The field Invalidation Queue Error Info (IQEI) in this register enumerates the details about what caused the IQE field to be set. The IQEI field may be enhanced to report additional error information, for instance, by utilizing bits 3:0 (which are currently reserved), as an example an IQEI [3:0] field may be defined to be populated with detail about what caused the IQE field to be set, for instance: Invalid Flags: 0x8; ATS and ATC not enabled: 0x9; Invalid PASID for reset: 0xA; Invalid DID for reset: 0xB; among other examples.

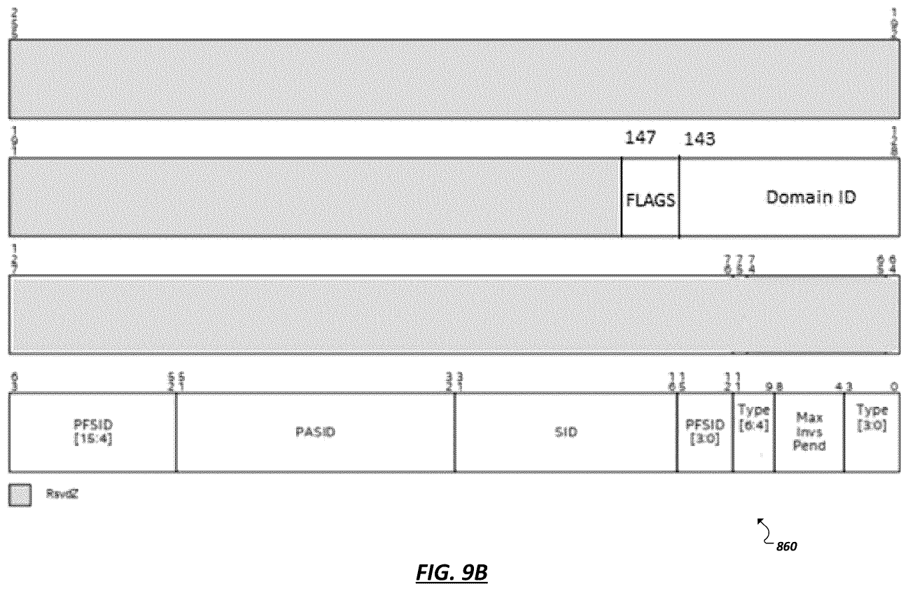

In some implementations, a physical device's ATC or other tables may be extended to store Domain ID information in the device, such as illustrated in the example tables 1005, 1010 of FIG. 10. For instance, when the IOMMU provides a DID/PASID through the BTRS descriptor, the device can then update the Device Process cache with the fields of the descriptor. The device can then utilize the table to match subsequent requests and filter out the requests that originated from the rogue address space(s), among other examples.

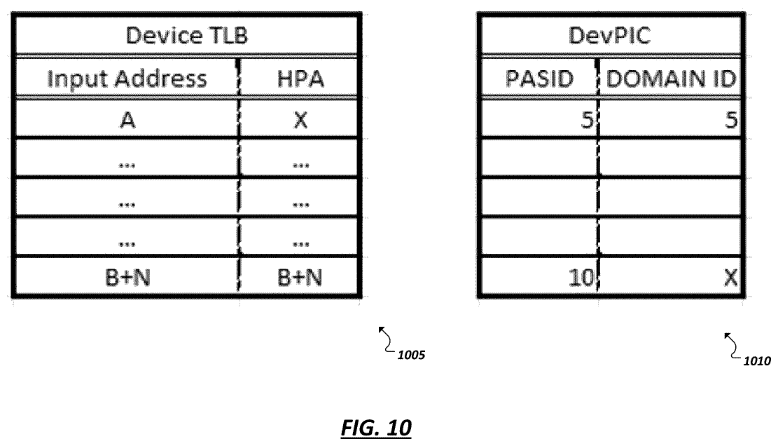

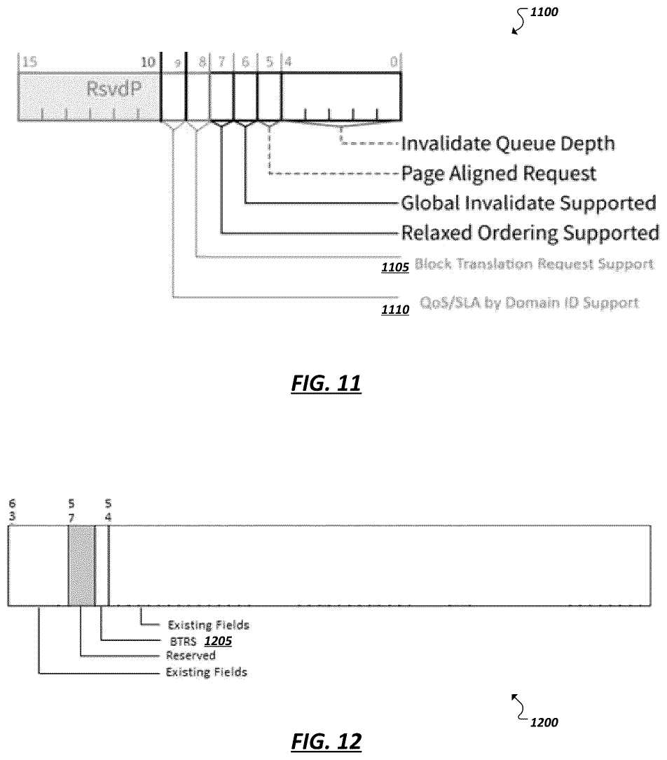

In some ATS-based implementations, the IOMMU may send a BTRS Start or BTRS Reset descriptor to enabled or disable blocking of address translations associated with a given guest process or address space. For instance, turning to FIG. 11, a bit may be exposed in a capability register of the address translation resource (e.g., IOMMU) to show support for the defined blocking and reset messages. Further, in some implementations, it may be a precondition for system software to participate in fault handling by issuing requests to block or reset a particular guest address space of process, related remapping and translation hardware (e.g., IOMMU) will advertise that it supports the BTRS feature through its capability register, among other examples. As shown in FIG. 12, an example IOMMU Extended Capability Register [ECAP_REG] 1200 is shown reporting remapping hardware extended capabilities. In one example, an available reserved bit (bit 54) can be used to report the support of blocking and reset messages as discussed herein, among other example information.

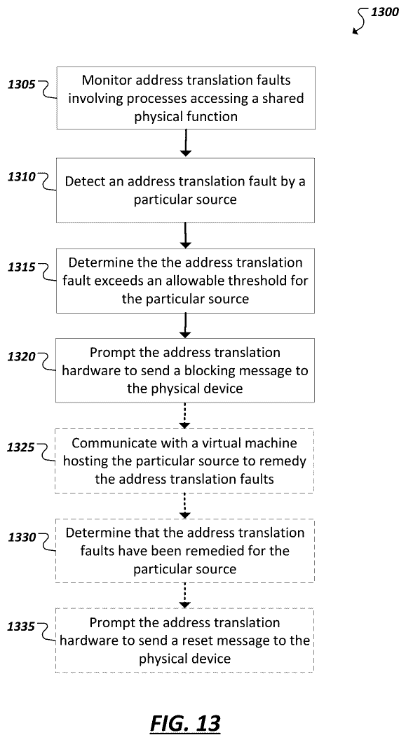

FIG. 13 is a simplified flow diagram 1300 of an example technique for determining that a given process (e.g., a thread, application, microservice, driver, etc.) running in a guest (e.g., a virtual machine or container) is sending faulting addresses in requests to a physical device in association with work requests to a virtualization (e.g., VF or ADI) of a physical function of the device. For instance, a software tool (e.g., in a host operating system or other system software) may track 1305 the occurrence of address translation faults across a system (e.g., a system of virtual machines and their guest processes accesses one or a variety of different virtualization of various physical functions provided by various physical devices (e.g., hardware accelerators, network controllers, memory management devices, processor devices, etc.). For instance, when a work request is determined to carry a bad or incorrect virtual address in a guest address space, a recoverable or non-recoverable fault may be detected (e.g., as reported by an address translation device (e.g., IOMMU) tasked with handling a related address translation request (from a corresponding one of the physical devices being virtualized).

Continuing with the example of FIG. 13, as the system software monitors and records faults at a guest process level across the system, the system software may detect a pattern of address translation faults based on guest addresses provided by a given guest process running on the system (and referencing a particular one of multiple guest address spaces in the guests running on the system). The system software may detect a latest address translation fault by the given guest process (e.g., as reported by one of the address translation resources shared on the system (e.g., in connection with fault handling by the address translation resource (e.g., according to a ATS or PRS protocol))). Based on this latest address translation fault (e.g., and in connection with a history of potentially other earlier address translation faults by the given guest process (e.g., relating to work requests by the given guest process to a virtualized instance of the same or multiple different physical functions provided by various physical devices on the system)), the system software may conclude that the number, character (e.g., recoverable faults vs. non-recoverable faults, the various bad guest addresses provided that caused the fault (e.g., a single, repeated bad address vs. different bad addresses), etc.), and/or frequency of faulting addresses (and corresponding failed address translation attempts) rises above an allowable frequency for the given guest process or its virtual machine. In some instance, based on a service level, customer associate, process type, or other attribute, the system software may allow a higher tolerance for failed address translation requests from one guest process or virtual machine, than from other guest process (and/or other virtual machines or virtual address spaces), and may apply a specific one of potentially multiple different thresholds to a given guest process. If the system software determines that this acceptable threshold has been met (or, alternatively, exceeded), the system software may determine that future address translation attempts associated with the given guest processes work requests (of the same physical device or multiple different physical devices in the system), should be blocked. Accordingly, the system software may prompt the sending of a blocking message (e.g., by a related IOMMU) to the physical device. In the case were the system software determines that the given guest process's address translations should be blocked across multiple (or even all) virtualized instances of shared physical devices and their physical functions in the system, the system software may prompt multiple blocking messages to be sent to the associated physical devices to cause these physical devices to identify that address translation requests associated with work requests by the given guest process, its guest address space, or even its VM, should be dropped by the respective physical device and not passed to corresponding address translation hardware to potentially bog down the address translation hardware with additional faults and free up the address translation hardware for legitimate address translations.

Continuing with the example of FIG. 13, in some implementations, system software may also participate in trouble shooting or resolution of guest process, address space, or VM that has been blocked. For instance, the system software may include processes to re-validate a guest and its address space, detect and repair an issue causing the detected pattern of faulty addresses, among other examples. The system software may communicate 1325 with the VM, a VMM, hypervisor, guest OS, or other entity to remedy the cause of the faulty addresses (e.g., including restarting or terminating a particular guest process that is the specific source of the trouble). Based on these actions and communication, the system software may determine 1330 that address translation requests from the blocked guest sender (e.g., a particular process, a guest address space, a given VM, etc.) may be unblocked and again allowed. In some cases, this allowance may be probationary, with future address translation faults causing (e.g., an even faster) reentry of the guest sender into a blocked state (e.g., through the sending of another corresponding blocking message). To unblock the guest sender, the system software may prompt the sending of a reset message (e.g., to be sent by one or more IOMMUs to one or more attached physical devices handling work processes from guests), which may cause physical devices to again proceed with any necessary address translation requests relating to virtual guest addresses included in work requests, such as detailed in the other examples above.

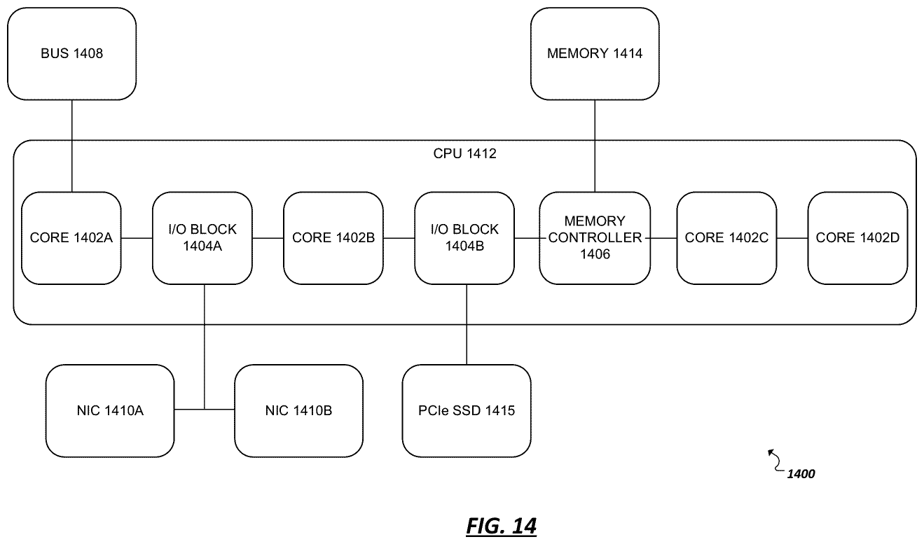

Note that the apparatus', methods', and systems described above may be implemented in any electronic device or system as aforementioned. As a specific illustration, FIG. 14 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 14, a block diagram 1400 is shown of an example data processor device (e.g., a central processing unit (CPU)) 1412 coupled to various other components of a system in accordance with certain embodiments. Although CPU 1412 depicts a particular configuration, the cores and other components of CPU 1412 may be arranged in any suitable manner. CPU 1412 may comprise any processor or processing device, such as a microprocessor, an embedded processor, a digital signal processor (DSP), a network processor, an application processor, a co-processor, a system on a chip (SOC), system in package (SIP) (e.g., a device with interconnected chiplets on a single package), or other device to execute code. CPU 1412, in the depicted embodiment, includes four processing elements (cores 1402 in the depicted embodiment), which may include asymmetric processing elements or symmetric processing elements. However, CPU 1412 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1412, as illustrated in FIG. 14, includes four cores-cores 1402A, 1402B, 1402C, and 1402D, though a CPU may include any suitable number of cores. Here, cores 1402 may be considered symmetric cores. In another embodiment, cores may include one or more out-of-order processor cores or one or more in-order processor cores. However, cores 1402 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1402 may include a decode module coupled to a fetch unit to decode fetched elements. Fetch logic, in one embodiment, includes individual sequencers associated with thread slots of cores 1402. Usually a core 1402 is associated with a first ISA, which defines/specifies instructions executable on core 1402. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1402 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1402, in one embodiment, recognize the same ISA (or a subset thereof). Alternatively, in a heterogeneous core environment, a decoder of one or more cores (e.g., core 1402B) may recognize a second ISA (either a subset of the first ISA or a distinct ISA).

In various embodiments, cores 1402 may also include one or more arithmetic logic units (ALUs), floating point units (FPUs), caches, instruction pipelines, interrupt handling hardware, registers, or other suitable hardware to facilitate the operations of the cores 1402.

Bus 1408 may represent any suitable interconnect coupled to CPU 1412. In one example, bus 1408 may couple CPU 1412 to another CPU of platform logic (e.g., via UPI). I/O blocks 1404 represents interfacing logic to couple I/O devices 1410 and 1415 to cores of CPU 1412. In various embodiments, an I/O block 1404 may include an I/O controller that is integrated onto the same package as cores 1402 or may simply include interfacing logic to couple to an I/O controller that is located off-chip. As one example, I/O blocks 1404 may include PCIe interfacing logic. Similarly, memory controller 1406 represents interfacing logic to couple memory 1414 to cores of CPU 1412. In various embodiments, memory controller 1406 is integrated onto the same package as cores 1402. In alternative embodiments, a memory controller could be located off chip.

As various examples, in the embodiment depicted, core 1402A may have a relatively high bandwidth and lower latency to devices coupled to bus 1408 (e.g., other CPUs 1412) and to NICs 1410, but a relatively low bandwidth and higher latency to memory 1414 or core 1402D. Core 1402B may have relatively high bandwidths and low latency to both NICs 1410 and PCIe solid state drive (SSD) 1415 and moderate bandwidths and latencies to devices coupled to bus 1408 and core 1402D. Core 1402C would have relatively high bandwidths and low latencies to memory 1414 and core 1402D. Finally, core 1402D would have a relatively high bandwidth and low latency to core 1402C, but relatively low bandwidths and high latencies to NICs 1410, core 1402A, and devices coupled to bus 1408.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a first interface to receive a work request from a virtual machine associated with a request for a physical function, where the work request identifies a virtual address within a guest address space associated with the virtual machine; a second interface to: send an address translation request to an address translation resource to translate the virtual address to a corresponding physical address in a physical address space; and receive a blocking message from the address translation resource based on a determination that the virtual address is a faulty address and the blocking message identifies a source of the faulty address; and circuitry to prevent a later address translation request for a later work request from the source based on the blocking message.

Example 2 includes the subject matter of example 1, where the circuitry is to allow other address translation requests for other work requests from other sources while address translation requests for work requests from the source are prevented. In some instances, at least one of the other sources run on the virtual machine with the source.

Example 3 includes the subject matter of any one of examples 1-2, where the blocking message is based on an Address Translation Service (ATS)-based protocol.

Example 4 includes the subject matter of example 3, where the blocking message includes a flag field encoded to indicate which identifiers associated with the source are to be used to identify that the later work request is to be blocked.

Example 5 includes the subject matter of example 4, where the identifiers associated with the source include an identifier of the guest address space and an identifier of the virtual machine.

Example 6 includes the subject matter of any one of examples 1-5, where the second interface is further to receive a reset message from the address translation resource, and the reset message identifies the source, where the circuitry is to reallow address translation requests for work requests from the source based on the reset message.

Example 7 includes the subject matter of any one of examples 1-6, further including hardware circuitry to implement the physical function.

Example 8 includes the subject matter of example 7, further including resources to implement virtual instances of the physical function based on Single Root I/O Virtualization (SR-IOV) or Scalable IOV (SIOV).

Example 9 includes the subject matter of any one of examples 1-8, where the source includes one of an application or a driver run on the virtual machine.

Example 10 includes the subject matter of any one of examples 1-9, where the physical device includes a hardware accelerator.

Example 11 includes the subject matter of any one of examples 1-10, where the address translation resource includes an input/output memory management unit (IOMMU).

Example 12 includes the subject matter of any one of examples 1-11, where the address translation hardware includes a fault handler to record details of a fault based on the virtual address being incorrect.

Example 13 is a non-transitory machine readable storage medium with instructions stored thereon, the instructions executable by a machine to cause the machine to: determine that a sender in a virtual machine sends incorrect addresses in work requests for a virtual function, where the virtual function corresponds to a physical function on a device, access to the physical function is shared through virtualization of the physical function, where translation hardware is to be used to translate virtual addresses in work requests issued to the virtual function to a physical address space; and modify operation of the device to block translations of subsequent work requests of the sender by the translation hardware.

Example 14 includes the subject matter of example 13, where the instructions are further executable to cause the machine to cause a blocking message to be sent from the translation hardware to the device to modify operation of the device, where the message includes an identifier of the sender and a request to prevent subsequent address translation requests from the device to the translation hardware associated with the subsequent work requests of the sender.

Example 15 includes the subject matter of example 14, where the instructions are further executable to cause the machine to: determine a pattern of incorrect addresses in work requests by the sender; and determine that the pattern of incorrect address violates a policy, where the message is sent based on violation of the policy by the sender.

Example 16 includes the subject matter of example 14, where the sender includes a process in a plurality of processes running in the virtual machine, and the identifier identifies the process.

Example 17 includes the subject matter of any one of examples 10-16, where the instructions are further executable to cause the machine to: determine a resolution for the sender to prevent inclusion of incorrect addresses in future work requests of the sender; and modify operation of the device to allow translation requests for the future work requests to proceed from the device to the translation hardware.

Example 18 is a method including: determining that a sender in a virtual machine sends incorrect addresses in work requests for a virtual function, where the virtual function corresponds to a physical function on a device, access to the physical function is shared through virtualization of the physical function, where translation hardware is to be used to translate virtual addresses in work requests issued to the virtual function to a physical address space; and modifying operation of the device to block translations of subsequent work requests of the sender by the translation hardware.

Example 19 includes the subject matter of example 18, further including causing a blocking message to be sent from the translation hardware to the device to modify operation of the device, where the message includes an identifier of the sender and a request to prevent subsequent address translation requests from the device to the translation hardware associated with the subsequent work requests of the sender.

Example 20 includes the subject matter of example 19, further including: determining a pattern of incorrect addresses in work requests by the sender; and determining that the pattern of incorrect address violates a policy, where the message is sent based on violation of the policy by the sender.

Example 21 includes the subject matter of any one of examples 19-20, where the sender includes a process in a plurality of processes running in the virtual machine, and the identifier identifies the process.

Example 22 includes the subject matter of any one of examples 18-21, where the instructions are further executable to cause the machine to: determining a resolution for the sender to prevent inclusion of incorrect addresses in future work requests of the sender; and modifying operation of the device to allow translation requests for the future work requests to proceed from the device to the translation hardware.

Example 23 is a system including means to perform the method of any one of examples 18-22.

Example 24 is an apparatus including: one or more address translation structures to map addresses in a plurality of different virtual address spaces to addresses in a physical address space; a first interface to receive an address translation request from a physical device, where the physical device includes a physical function to be shared by a plurality of guests through virtualization of the physical function, the address translation requests corresponds to a work request from a source in the plurality of guests for the physical device, and the address translation request identifies a virtual address in an address space of one of the plurality of guests; address translation circuitry to: attempt to translate the virtual address to a physical address in the physical address space; and determine a fault in the virtual address based on the attempt to translate the virtual address; and a second interface to receive an indication from system software that subsequent address translation requests from the source are to be blocked; and protocol circuitry to send a blocking message to the physical device, where the blocking message identifies the source and causes the physical device to prevent submission of subsequent address translation requests from the source.

Example 25 includes the subject matter of example 24, where the apparatus includes an IOMMU.

Example 26 is a system including: system software to support a plurality of virtual machines, where a plurality of different guest address spaces are associated with the plurality of virtual machines; a physical memory, where a physical address space is associated with the physical memory; a physical device including circuitry to implement a physical function, where the physical function is to be shared by the plurality of virtual machines through virtualization of the physical function, where the physical device is to receive a work request from a sender in one of the plurality of virtual machines, and the work request identifies a virtual address in a guest address space in the plurality of different guest address spaces; address translation hardware to: attempt to translate the virtual address in the work request; determine that the virtual address is incorrect; and send a blocking message to the physical device, where the blocking message identifies the sender and is based on determination that the virtual address is incorrect, where the physical device is to prevent subsequent address translation requests to the address translation hardware for subsequent work requests from the sender based on the blocking message.

Example 27 includes the subject matter of example 26, where the system software includes logic executable to: determine, based on inclusion of the incorrect virtual address in the work request, that the sender sends incorrect virtual addresses in work requests beyond an acceptable threshold; and prompt the address translation to send the blocking message to the physical device.

Example 28 includes the subject matter of any one of examples 26-27, where the physical device includes a hardware accelerator.

Example 29 includes the subject matter of any one of examples 26-28, where the address translation hardware includes an input/output memory management unit (IOMMU).

Example 30 includes the subject matter of any one of examples 26-29, where the address translation hardware includes a fault handler to record details of a fault based on the virtual address being incorrect.

Example 31 includes the subject matter of any one of examples 26-30, where the circuitry is to allow other address translation requests for other work requests from other sources while address translation requests for work requests from the source are prevented.

Example 32 includes the subject matter of example 31, where at least one of the other sources run on the virtual machine with the source.

Example 33 includes the subject matter of any one of examples 26-32, where the blocking message is based on an Address Translation Service (ATS)-based protocol.

Example 34 includes the subject matter of example 33, where the blocking message includes a flag field encoded to indicate which identifiers associated with the source are to be used to identify that the later work request is to be blocked.

Example 35 includes the subject matter of example 34, where the identifiers associated with the source include an identifier of the guest address space and an identifier of the virtual machine.

Example 36 includes the subject matter of any one of examples 26-35, where the second interface is further to receive a reset message from the address translation resource, and the reset message identifies the source, where the circuitry is to reallow address translation requests for work requests from the source based on the reset message.

Example 37 includes the subject matter of any one of examples 26-36, further including resources to implement virtual instances of the physical function based on Single Root I/O Virtualization (SR-IOV) or Scalable IOV (SIOV).

Example 38 includes the subject matter of any one of examples 26-37, where the source includes one of an application or a driver run on the virtual machine.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a first interface to receive a work request from a virtual machine, wherein the work request identifies a virtual address within a guest address space associated with the virtual machine and associated with a request for a physical function;
a second interface to:
send an address translation request to an address translation resource to translate the virtual address to a corresponding physical address in a physical address space; and
receive a blocking message from the address translation resource based on a determination that the virtual address is a faulty address and the blocking message identifies a source of the faulty address; and
circuitry to prevent a later address translation request for a later work request from the source based on the blocking message.

2. The apparatus of claim 1, wherein the circuitry is to allow other address translation requests for other work requests from other sources while address translation requests for work requests from the source are prevented.

3. The apparatus of claim 1, wherein the blocking message is based on an Address Translation Service (ATS)-based protocol.

4. The apparatus of claim 3, wherein the blocking message comprises a flag field encoded to indicate which identifiers associated with the source are to be used to identify that the later work request is to be blocked.

5. The apparatus of claim 4, wherein the identifiers associated with the source comprise an identifier of the guest address space and an identifier of the virtual machine.

6. The apparatus of claim 1, wherein the second interface is further to receive a reset message from the address translation resource, and the reset message identifies the source, wherein the circuitry is to reallow address translation requests for work requests from the source based on the reset message.

7. The apparatus of claim 1, further comprising hardware circuitry to implement the physical function.

8. The apparatus of claim 7, further comprising resources to implement virtual instances of the physical function based on Single Root I/O Virtualization (SR-IOV) or Scalable IOV (SIOV).

9. The apparatus of claim 1, wherein the source comprises one of an application or a driver run on the virtual machine.

10. At least one non-transitory machine readable storage medium with instructions stored thereon, the instructions executable by a machine to cause the machine to:
determine that a sender in a virtual machine sends faulty addresses in work requests for a virtual function, wherein the virtual function corresponds to a physical function on a device, access to the physical function is shared through virtualization of the physical function, wherein translation hardware is to be used to translate virtual addresses in work requests issued to the virtual function to a physical address space; and
modify operation of the device to block translations of subsequent work requests of the sender by the translation hardware.

11. The storage medium of claim 10, wherein the instructions are further executable to cause the machine to cause a blocking message to be sent from the translation hardware to the device to modify operation of the device, wherein the message comprises an identifier of the sender and a request to prevent subsequent address translation requests from the device to the translation hardware associated with the subsequent work requests of the sender.

12. The storage medium of claim 11, wherein the instructions are further executable to cause the machine to:
determine a pattern of faulty addresses in work requests by the sender; and
determine that the pattern of faulty address violates a policy, wherein the message is sent based on violation of the policy by the sender.

13. The storage medium of claim 11, wherein the sender comprises a process in a plurality of processes running in the virtual machine, and the identifier identifies the process.

14. The storage medium of claim 10, wherein the instructions are further executable to cause the machine to:
determine a resolution for the sender to prevent inclusion of faulty addresses in future work requests of the sender; and
modify operation of the device to allow translation requests for the future work requests to proceed from the device to the translation hardware.

15. A system comprising:
system software to support a plurality of virtual machines, wherein a plurality of different guest address spaces are associated with the plurality of virtual machines;
a physical memory, wherein a physical address space is associated with the physical memory;
a physical device comprising circuitry to implement a physical function, wherein the physical function is to be shared by the plurality of virtual machines through virtualization of the physical function, wherein the physical device is to receive a work request from a sender in one of the plurality of virtual machines, and the work request identifies a virtual address in a guest address space in the plurality of different guest address spaces;
address translation hardware to:
attempt to translate the virtual address in the work request;
determine that the virtual address is incorrect; and
send a blocking message to the physical device, wherein the blocking message identifies the sender and is based on determination that the virtual address is incorrect,
wherein the physical device is to prevent subsequent address translation requests to the address translation hardware for subsequent work requests from the sender based on the blocking message.

16. The system of claim 15, wherein the system software comprises logic executable to:
determine, based on inclusion of the incorrect virtual address in the work request, that the sender sends incorrect virtual addresses in work requests beyond an acceptable threshold; and
prompt the address translation to send the blocking message to the physical device.

17. The system of claim 15, wherein the physical device comprises a hardware accelerator.

18. The system of claim 15, wherein the address translation hardware comprises an input/output memory management unit (IOMMU).

19. The system of claim 15, wherein the address translation hardware comprises a fault handler to record details of a fault based on the virtual address being incorrect.

20. The system of claim 15, wherein the virtual address is determined to be incorrect based on a lack of a mapping of the virtual address to a physical address in the system.
